(19) United States
(12) Patent Application Publication
(10) Pub. No.: US 2026/0016692 A1
(43) Pub. Date: Jan. 15, 2026

(54) PROJECTION UNIT FOR A HEAD-UP DISPLAY

(71) Applicant: Harman Becker Automotive Systems GmbH, Karlsbad (DE)

(72) Inventors: Peter BRANDT, Pfinztal (DE); Joerg WELKE, Ettlingen-Schöllbronn (DE)

(73) Assignee: Harman Becker Automotive Systems GmbH, Karlsbad (DE)

(21) Appl. No.: 19/331,463

(22) Filed: Sep. 17, 2025

Related U.S. Application Data
(63) Continuation of application No. PCT/EP2023/057149, filed on Mar. 21, 2023.

(51) Int. Cl. G02B 27/01

(52) U.S. Cl. CPC G02B 27/0101; G02B 2027/0127

(57) ABSTRACT

A projection unit for a head-up display including a projector element and a mirror arrangement. The projector element is configured to emit a light beam. The mirror arrangement includes a first mirror and a second mirror. The first mirror is a flat mirror. The second mirror is a flat mirror spaced apart from and in parallel to the first mirror. The projector element is configured to emit the light beam towards the first mirror at an angle of incidence. The first mirror and the second mirror are arranged at a first distance from each other such that the light beam is repeatedly reflected from the first mirror towards the second mirror, and from the second mirror back towards the first mirror before leaving the mirror arrangement. At least one of the first distance between the first mirror and the second mirror, and the angle of incidence is adjustable.

### CROSS-REFERENCE TO RELATED APPLICATIONS

This application is a continuation of International Application No. PCT/EP2023/057149, filed on Mar. 21, 2023. The disclosures of the above applications are incorporated herein by reference.

### FIELD

The present disclosure relates to a projection unit for a head-up display, in particular for a head-up display of a vehicle.

### BACKGROUND

The statements in this section merely provide background information related to the present disclosure and may not constitute prior art.

Head-up displays, or heads-up displays, also known as HUDs are transparent displays that present data to a user without requiring the user to look away from their intended viewpoint. In a vehicle, for example, where a driver is generally required to look ahead onto the road in front of them, data may be presented to the driver on the windscreen of the vehicle. In particular, a virtual image is generated which is perceived by the driver at a certain distance in front of the windscreen. Known head-up displays are generally able to present information to the driver at only two different virtual distances, e.g., at either 7 m or 10 meters in front of the driver. Even further, the different elements required to implement a head-up display (i.e. the projection unit of the head-up display) usually require a comparably large assembly space. Assembly space, however, is generally limited in a vehicle. There is a need for a head-up display, i.e., a projection unit for a head-up display, and related method that are able to present images to the driver of a vehicle at a plurality of different virtual distances, while requiring only little assembly space.

### SUMMARY

This section provides a general summary of the disclosure and is not a comprehensive disclosure of its full scope or all of its features.

A projection unit for a head-up display includes a projector element configured to emit a light beam, and a mirror arrangement including a first mirror and a second mirror, wherein the first mirror is a flat mirror, the second mirror is a flat mirror arranged distant from and in parallel to the first mirror, the projector element is configured to emit the light beam towards the first mirror at a desired angle of incidence. The first mirror and the second mirror are arranged at a first distance from each other such that the light beam is repeatedly reflected from the first mirror towards the second mirror, and from the second mirror back towards the first mirror before leaving the mirror arrangement, and at least one of the first distance between the first mirror and the second mirror, and the angle of incidence is adjustable.

A vehicle includes a windscreen and a projection unit. The projection unit is arranged to project the light beam emitted by the projector element onto the windscreen.

A method includes emitting a light beam towards a mirror arrangement by means of a projector element, and, when the light beam leaves the mirror arrangement, projecting the light beam on a projection surface. The mirror arrangement includes a first mirror 24 and a second mirror 26, wherein the first mirror 24 is a flat mirror, the second mirror 26 is a flat mirror arranged distant from and in parallel to the first mirror 24. The projector element 22 is configured to emit the light beam 40 towards the first mirror 24 at a desired angle of incidence [symbol] ±. The first mirror 24 and the second mirror 26 are arranged at a first distance d1 from each other such that the light beam 40 is repeatedly reflected from the first mirror 24 towards the second mirror 26, and from the second mirror 26 back towards the first mirror 24 before leaving the mirror arrangement 202, and at least one of the first distance d1 between the first mirror 24 and the second mirror 26, and the angle of incidence [symbol] ± is adjustable.

Other systems, methods, features and advantages of the present disclosure will be or will become apparent to one with skill in the art upon examination of the following detailed description and figures. It is intended that all such additional systems, methods, features and advantages be included within this description, be within the scope of the invention and be protected by the following claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The arrangements may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 is a schematic view illustrating a vehicle with a head-up display in accordance with the teachings of the present disclosure;

FIG. 2 is a schematic view illustrating the general principle of a head-up display in a vehicle;

FIGS. 3 to 5 are schematic views illustrating a mirror arrangement of a projection unit for a head-up display according to one or more embodiments of the present disclosure;

FIG. 6 is a schematic view illustrating a mirror arrangement of a projection unit for a head-up display according to one or more embodiments of the present disclosure;

FIG. 7 is a schematic view illustrating a head-up display according to one or more embodiments of the present disclosure; and

FIG. 8 is a flow chart illustrating a method for emitting a light beam towards a mirror arrangement according to one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Detailed examples of the present disclosure are disclosed herein; however, it is to be understood that the disclosed examples are merely examples that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

It is recognized that directional terms that may be noted herein (e.g., “upper”, “lower”, “inner”, “outer”, “top”, “bottom”, etc.) simply refer to the orientation of various components of an arrangement as illustrated in the accompanying figures. Such terms are provided for context and understanding of the disclosed one or more embodiments.

The projection unit for a head-up display and related methods according to the various examples described herein are able to provide virtual images at many different virtual distances to a driver of a vehicle. At the same time, little assembly space is desired for the projection unit within the vehicle.

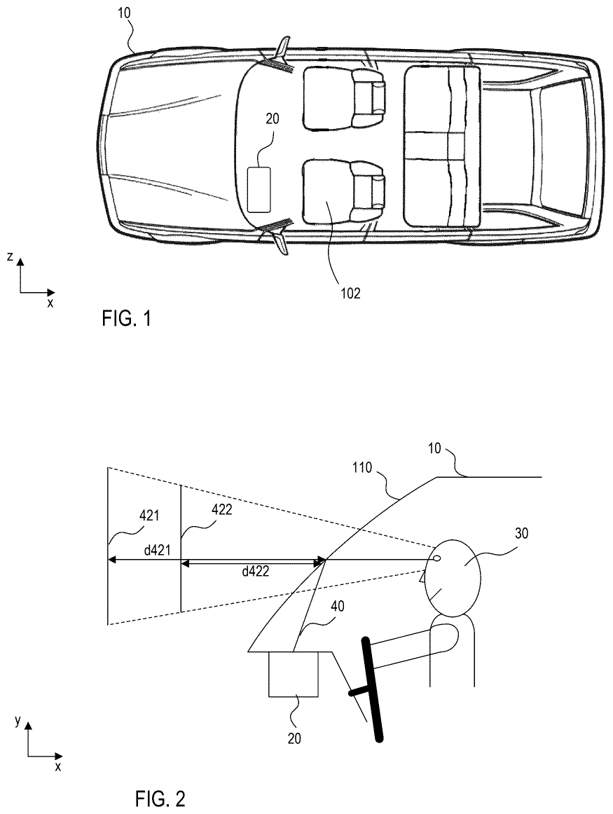

With reference to FIGS. 1 and 2, a vehicle 10 comprising a head-up display is provided. The head-up display comprises a projection unit 20. The projection unit 20 is configured to transmit a light beam 40 (FIG. 2) via a mirror system to the windscreen 110 of the vehicle 10. The projection unit 20 is usually arranged in a position below the surface the light beam 40 is to be projected on. That is, the projection unit 20 may be arranged below the windscreen 110 in front of a driver's seat of the vehicle 10. When the head-up display is activated, the driver 30 of the vehicle 10 seated on the driver's seat perceives information that is projected on the windscreen 110 at a certain distance in front of the windscreen and, therefore, does not lose contact with the road in front of them. Head-up displays may improve situational awareness and reduce the desire to look away from the road while driving. This shortens the reaction time and gives the driver 30 a better chance of reacting to driving obstacles such as, e.g., pedestrians, wild animals, or others. The use of head-up displays may further increase the overall quality of driving. For example, navigation information may be presented to a driver 30 of a vehicle 10 by means of a head-up display. Head-up displays, however, may be used to present any other information that may be useful for the driver as well.

The information presented to the driver 30 by means of the head-up display is generally perceived at a certain distance in front of the windscreen 110. That is, the head-up display is configured to generate a virtual image 421, 422 (FIG. 2) in front of the windscreen 110. For example, the driver 30 may perceive road signs presented by the head-up display as lying on the road surface in front of them. Conventional head-up displays are generally configured to present information to the driver 30 at two different distances d421, d422 in front of the windscreen 110. For example, information may be presented at a first distance d422 of about 7 m, or at a second distance d421 of about 10 m in front of the windscreen 110, or in front of the driver 30. Projection units 20 for head-up displays are usually large and require a comparably large assembly space within the vehicle 110.

Now referring to FIGS. 3, 4 and 5, a mirror arrangement 202 for a projection unit 20 for a head-up display according to one or more embodiments of the present disclosure is described. When using the mirror arrangement 202 in a projection unit 20 of a head-up display, the overall assembly space by the projection unit 20 may be significantly decreased. At the same time, when using the mirror arrangement 202 according to one or more embodiments of the disclosure, information may be presented to a driver 30 of a vehicle at a plurality of different distances in front of the windscreen 110. The projection unit 20 comprises a projector element 22 and the mirror arrangement 202. The projector element 22 is configured to emit a light beam 40 towards the mirror arrangement 202. The light beam 40 passes through the mirror arrangement 202 and is then projected (e.g., via additional mirror elements) onto a desired surface, e.g., the windscreen 110 of a vehicle. The projector element 22 may be a conventional projector element used in conventional head-up displays, for example. According to one example, a projector element 22 may comprise a light source, and one or more optical elements (e.g., one or more lenses). A projector element 22 may comprise a liquid crystal display (LCD) display with a light emitting diode (LED) backlight unit as a light source, for example. Projector elements 22 suitable for the use in head-up displays, however, are generally known and will not be described in further detail herein.

The mirror arrangement 202 comprises a first mirror 24 and a second mirror 26. The first mirror 24 and the second mirror 26 are both flat mirrors that are arranged distant from and in parallel to each other. The projector element 22 is configured to emit the light beam 40 towards the first mirror 24 at a desired angle of incidence [symbol] ±. The first mirror 24 and the second mirror 26 are arranged at a first distance d1 from each other such that the light beam 40 is repeatedly reflected from the first mirror 24 towards the second mirror 26, and from the second mirror 26 back towards the first mirror 24 before leaving the mirror arrangement 202.

As the light beam 40 is repeatedly reflected between the first and second mirrors 24, 26, the travelling distance of the light beam 40 is increased. When the light beam 40 finally leaves the mirror arrangement 202, it is projected onto a suitable surface such as, e.g., the windscreen 110 of a vehicle 10. The light beam 40 may be reflected from further mirror elements after leaving the mirror arrangement 202 and before impinging upon the windscreen 110, which will be described with respect to FIG. 7 below. The distance d421, d422 at which the driver 30 of the vehicle 10 perceives the information presented to them depends on the overall travelling distance of the light beam 40. In particular, the longer the light travelling distance, the greater the virtual distance at which the driver 30 perceives the information in front of them. The virtual distance at which the information is perceived by the driver 30, therefore, can be increased or decreased by increasing or decreasing the light travelling distance of the light beam 40.

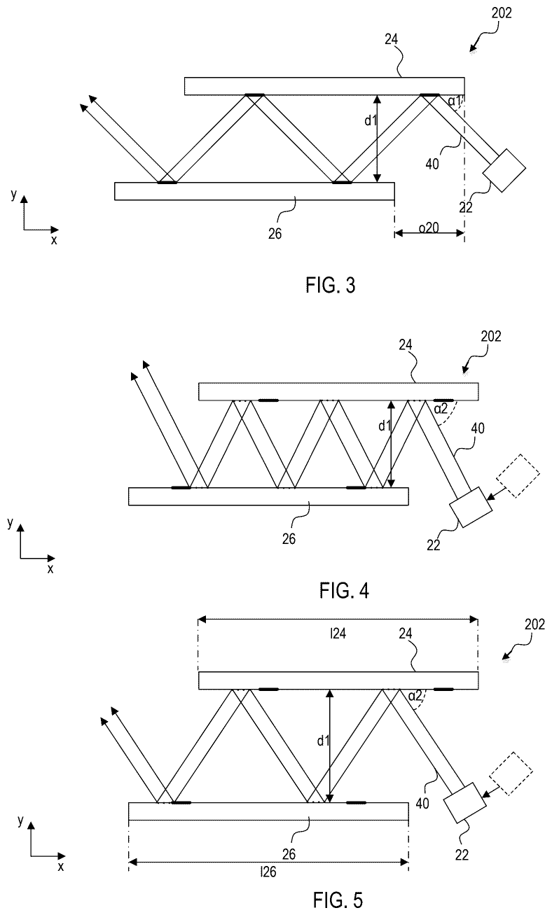

Therefore, at least one of the first distance d1 between the first mirror 24 and the second mirror 26, and the angle of incidence [symbol] ± is adjustable. Referring to FIG. 3, the first mirror 24 and the second mirror 26 are arranged at a specific first distance d1 from each other, and the light beam 40 is emitted by the projector element 22 towards the first mirror 24 at a first angle α1 of incidence [symbol] ±1. Now referring to FIG. 4, the first distance d1 between the first mirror 24 and the second mirror 26 remains the same as compared to the arrangement of FIG. 3. The light beam 40, however, in the example of FIG. 4, is emitted by the projector element 22 towards the first mirror 24 at a second angle α2 of incidence [symbol] ±2. The second angle α2 of incidence [symbol] ±2 is greater than the first angle α1 of incidence [symbol] ±1. Therefore, the light beam 40 impinges on the first mirror 24 significantly steeper. As a consequence, the light beam 40 is reflected between the first and second mirror 24, 26 more often as compared to the arrangement illustrated in FIG. 3. While in FIG. 3, the light beam 40 impinges on each of the first mirror 24 and the second mirror 26 twice, it impinges on each of the first mirror 24 and the second mirror 26 three times in FIG. 4. The light travelling distance of the light beam 40 therefore can be amended (increased or decreased) by emitting the light beam 40 at a different angle of incidence [symbol] ± with respect to the first mirror 24.

For example, the projector element 22 may movable with respect to the mirror arrangement in order to adjust the angle of incidence [symbol] ±. By moving the projector element 22 from a first position to a second position and/or rotating the projector element 22 in a suitable way, the angle of incidence [symbol] ± may be adjusted. Alternatively or additionally, at least one of the first mirror 24 and the second mirror 26 may be movable in order to adjust the first distance d1 between the first mirror 24 and the second mirror 26. For example, the projection unit 20 may comprise a first motor configured to move the first mirror 24 in order to increase or decrease the first distance d1. That is, the first mirror 24 may be moved towards the second mirror 26 in order to decrease the first distance d1, or the first mirror 24 may be moved away from the second mirror 26 in order to increase the first distance d1. Alternatively or additionally, the projection unit 20 may comprise a second motor configured to move the second mirror 26 in order to increase or decrease the first distance d1.

When the first distance d1 between the first mirror 24 and the second mirror 26 is decreased, the light travelling path of the light beam 40 generally decreases, and the light travelling path of the light beam 40 increases when the first distance d1 between the first mirror 24 and the second mirror 26 increases. That is, the virtual distance at which the information is perceived by the driver 30 of the vehicle 10 can be increased or decreased by increasing or decreasing the first distance d1 between the first mirror 24 and the second mirror 26. A mirror arrangement 202 in which the first mirror 24 and the second mirror 26 are arranged further away from each other (first distance d1 increased as compared to the arrangements of FIGS. 3 and 4) is schematically illustrated in FIG. 5. The angle of incidence [symbol] ±2 in the arrangement of FIG. 5 is the same as in the arrangement of FIG. 4. As can be seen, as the first distance d1 between the mirrors 24, 26 is increased, the light beam 40 is reflected from each of the mirrors 24, 26 less often (three times in FIG. 4, twice in FIG. 5). The overall travelling distance of the light beam 40 in the arrangement of FIG. 5, therefore, may be somewhat shorter as compared to the arrangement of FIG. 4, and somewhat longer as compared to the arrangement of FIG. 3. In this way, by suitably choosing the first distance d1 and/or the angle of incidence [symbol] ±, any virtual distance at which the information is perceived by the driver 30 can be potentially set.

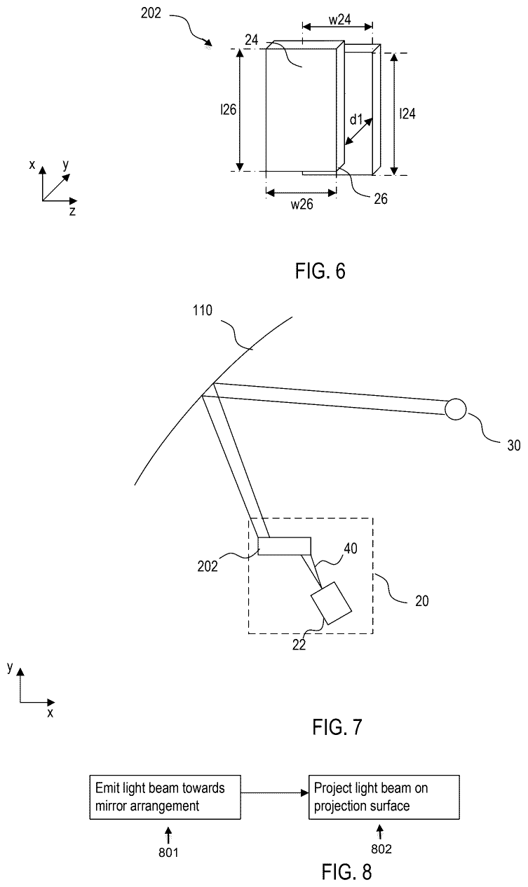

The mirror arrangement 202 and a projection unit 20 comprising the mirror arrangement 202 can be implemented in a very compact and space-saving manner as compared to projection units of conventional head-up displays. The first distance d1 between the first mirror 24 and the second mirror 26 may be between 2 cm and 10 cm, for example. A size of each of the first mirror 24 and the second mirror 26 can also be comparably small. The first mirror 24 may have a first length l24 and a first width w24, wherein the first length l24 may be between 5 cm and 15 cm, and the first width w24 may be between 3 cm and 15 cm, for example. According to another example, the first width w24 may be between 4 cm and 7 cm. The first width w24 may be identical to the first length l24 (first mirror 24 has a square shape), or may be smaller than the first length l24 (first mirror 24 has a rectangular shape). The first length l24 may be a length of the first mirror 24 in the direction x in which the light beam 40 travels. The same applies for the second mirror 26 which may have a second length l26 and a second width w26, wherein the second length l26 may be between 5 cm and 15 cm, and the second width w26 may be between 3 cm and 15 cm, for example. According to another example, the second width w26 may be between 4 cm and 7 cm. The second width w26 may be identical to the second length l26 (second mirror 26 has a square shape), or may be smaller than the second length l26 (second mirror 26 has a rectangular shape). The size of the first mirror 24 may be the same as the size of the second mirror 26 (first length l24=second length l26, and first width w24=second width w26), as is schematically illustrated in FIG. 6, for example. The first and second lengths l24, l26 as well as the first and second widths w24, w26 may be implemented as small as possible in order to reduce the assembly space as much as possible, but large enough to be able to present the desired information to the driver 30 of the vehicle at sufficient size and quality.

The first mirror 24 and the second mirror 26 may be aligned offset to each other in a first direction x, wherein the first direction x is a direction along which the light beam 40 is travelling. By arranging the first mirror 24 and the second mirror 26 offset to each other, the light beam 40 emitted by the projector element 22 may reach the first mirror 24 unhindered. That is, the second mirror 26 does not block the light beam 40 emitted by the projector element 22. In this way, a greater range of angles of incidence [symbol] ± is possible. Without an offset between the mirrors 24, 26, only comparably flat angles of incidence are generally possible. This might be sufficient for some applications, the arrangement, however, becomes more flexible when arranging the mirrors 24, 26 offset to each other. An offset o20 in the first direction x may be between 1 cm and 5 cm, for example. If the mirrors 24, 26 are identical in size, this also results in an equal offset at the opposite side of the mirror arrangement 202, where the light beam 40 leaves the mirror arrangement 202. The offset between the mirrors 24, 26 therefore also allows the light beam 40 to leave the mirror arrangement 202 unhindered at any desired angle.

Generally, it may be sufficient if the light beam 40 is reflected from each of the first mirror 24 and the second mirror 26 twice, as is schematically illustrated, for example, in FIGS. 3 and 5. The light beam 40, however, may also be reflected from each of the mirrors 24, 26 more than twice. For most applications, however, it may be sufficient if the light beam 40 is reflected from each of the first mirror 24 and the second mirror 26 five times at most. This is easily achievable by a comparably small mirror arrangement, e.g., by a mirror arrangement having the exemplary dimensions mentioned above.

Now referring to FIG. 7, a head-up display including a mirror arrangement 202 according to one or more embodiments of the disclosure is schematically illustrated. The projection unit 20 of the head-up display comprises the projector element 22 and the mirror arrangement 202 as described above. The light beam 40 generated by the projector element 22 and projected towards the mirror arrangement 202, after leaving the mirror arrangement 202, is reflected onto the windscreen 110. From there, it is reflected towards the eyes of a driver 30 of the vehicle, who perceives the information presented to them at a desired distance in front of the windscreen 110, wherein the desired distance depends on the first distance d1 between the mirrors 24, 26 of the mirror arrangement 202 and/or the angle of incidence [symbol] ±. The projection unit 20 according to one or more embodiments of the disclosure can be implemented in a very compact and space-saving way.

Now referring to FIG. 8, a method according to one or more embodiments of the disclosure is schematically illustrated. The method comprises emitting a light beam 40 towards a mirror arrangement 202 by means of a projector element 22, and, when the light beam 40 leaves the mirror arrangement 202, projecting the light beam 40 on a projection surface 110. As has been described above, the mirror arrangement 202 comprises a first mirror 24 and a second mirror 26, the first mirror 24 is a flat mirror, the second mirror 26 is a flat mirror arranged distant from and in parallel to the first mirror 24, the projector element 22 is configured to emit the light beam 40 towards the first mirror 24 at a desired angle of incidence [symbol] ±, the first mirror 24 and the second mirror 26 are arranged at a first distance d1 from each other such that the light beam 40 is repeatedly reflected from the first mirror 24 towards the second mirror 26, and from the second mirror 26 back towards the first mirror 24 before leaving the mirror arrangement 202, and at least one of the first distance d1 between the first mirror 24 and the second mirror 26, and the angle of incidence [symbol] ± is adjustable.

With the projection unit 20 according to one or more embodiments of the present disclosure, it is further possible to reduce any unwanted reflections caused by sunrays entering the mirror arrangement and being reflected by at least one of the mirrors. In conventional projection units, reflections caused by sunrays entering the reflection unit may result in unwanted excessive heating of the projection unit. This may be reduced or even avoided by means of the projection unit 20 described herein.

A projection unit 20 according to one or more embodiments of the disclosure has been described with reference to a head-up display in a passenger car above. Head-up displays, however, may be used within any other kind of vehicle as well such as, e.g., busses, planes, ships, etc.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should not be understood as excluding the plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly disclose subject matter from the above description that is regarded to be novel and non-obvious.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A projection unit for a head-up display comprises:
a projector element configured to emit a light beam; and
a mirror arrangement comprising a first mirror and a second mirror, wherein the first mirror is a flat mirror, the second mirror is a flat mirror arranged distant from and in parallel to the first mirror,
wherein the projector element is configured to emit the light beam towards the first mirror at an angle of incidence,
wherein the first mirror and the second mirror are arranged at a first distance from each other such that the light beam is repeatedly reflected from the first mirror towards the second mirror, and from the second mirror back towards the first mirror before leaving the mirror arrangement, and
wherein at least one of the first distance between the first mirror and the second mirror, and the angle of incidence is adjustable.

2. The projection unit of claim 1, wherein the first distance between the first mirror and the second mirror is adjustable between 2 cm and 10 cm.

3. The projection unit of claim 1, wherein the light beam is reflected from each of the first mirror and the second mirror at least twice.

4. The projection unit of any of claim 1, wherein the light beam is reflected from each of the first mirror and the second mirror five times at most.

5. The projection unit of claim 1, further comprising a first motor, wherein the first motor is configured to move the first mirror in order to increase or decrease the first distance.

6. The projection unit of claim 1, further comprising a second motor, wherein the second motor is configured to move the second mirror in order to increase or decrease the first distance.

7. The projection unit of claim 1, wherein the projector element is movable with respect to the mirror arrangement in order to adjust the angle of incidence.

8. The projection unit of claim 1, wherein the first mirror and the second mirror are aligned offset to each other in a first direction, wherein the first direction is a direction along which the light beam is reflected between the first mirror and the second mirror.

9. The projection unit of claim 1, wherein the first mirror has a first length in the first direction, and the second mirror has a second length in the first direction, and wherein the first length and the second length each are between 5 cm and 15 cm.

10. The projection unit of claim 1, wherein the first mirror has a first width in a second direction perpendicular to the first direction, and the second mirror has a second width in the second direction, and wherein the first width and the second width each are between 3 cm and 15 cm.

11. A vehicle comprising:
a windscreen; and
a projection unit according to claim 1, wherein the projection unit is arranged to project the light beam emitted by the projector element onto the windscreen.

12. A method comprising:
emitting a light beam towards a mirror arrangement by means of a projector element; and
projecting the light beam on a projection surface when the light beam leaves the mirror arrangement, wherein:
the mirror arrangement comprises a first mirror and a second mirror, the first mirror is a flat mirror, the second mirror is a flat mirror arranged distant from and in parallel to the first mirror, the projector element is configured to emit the light beam towards the first mirror at an angle of incidence, the first mirror and the second mirror are arranged at a first distance from each other such that the light beam is repeatedly reflected from the first mirror towards the second mirror, and from the second mirror back towards the first mirror before leaving the mirror arrangement, and
at least one of the first distance between the first mirror and the second mirror, and the angle of incidence is adjustable.
